(19) United States
(12) Patent Application Publication
(10) Pub. No.: US 2014/0372241 A1
(43) Pub. Date: Dec. 18, 2014

(54) SYSTEM FOR THE SALE OF FOOD VIA AN INTERNET PLATFORM

(71) Applicant: RIEBER AG, ESCHLIKON (CH)

(72) Inventor: Max Maier, Ludwigsburg (DE)

(21) Appl. No.: 14/372,951

(22) PCT Filed: Dec. 20, 2012
(86) PCT No.: PCT/EP2012/076523

§ 371 Date: Jul. 17, 2014

(30) Foreign Application Priority Data
Jan. 19, 2012 (DE) 10 2012 000 924.0

(51) Int. Cl. G06Q 10/08; G06Q 10/00; G06Q 30/06

(52) U.S. Cl. CPC G06Q 10/083; G06Q 30/0601; G06Q 10/30
USPC 705/26.1

(57) ABSTRACT

The invention relates to a system for the sale of packaged foodstuffs via an Internet platform between a supplier and a customer. The Internet platform is designed to present the offer of the supplier to the customers and to directly or indirectly establish contact between the customer and supplier via a transport company to deliver food to the customer as packaged foodstuffs. The food is placed into reusable containers by the supplier, such that said food is kept hot or cooled. A transport company can optionally be connected to any supplier via the Internet platform to pick up an order of a customer that has been received by the Internet platform from the relevant supplier and deliver said order to the customer. A provider of reusable containers can be put into contact with any supplier to supply the latter with reusable containers.

### CROSS-REFERENCE TO RELATED APPLICATIONS

This application is a national phase application and claims priority to PCT/EP2012/076523, which was filed Dec. 20, 2012 and which is hereby incorporated by reference in its entirety. PCT/EP2012/076523 claims priority to German application DE 10 2012 000 924.0 filed Jan. 19, 2012.

### BACKGROUND OF THE INVENTION

1. Field of the Invention

The invention relates to a system for the sale of packaged food via an Internet platform provided between suppliers and customers.

2. Discussion of the Related Art

82 million people live in Germany. These 82 million people buy approximately 75 million tons of food per year. About 30% of it is thrown away because it is too much or perishable. The average food item travels approximately 4,000 km until it arrives on a consumer's plate. Food transport is not organised in Germany.

Almost 50 years ago, Rieber Co., Reutlingen, introduced the food service standard (the presently applicable standard is EN 631) for food containers in Europe. Almost 35 years ago, Rieber Co. introduced the last innovation in the field of GN, namely the combined steamer and the perforated GN container. A “cooking” GN container was launched on the market in 2005. These standardised containers are presently only used in “closed systems”. Even though every gastronomic business has GN containers, these GN containers never leave the own business. This is what the invention is based on, namely the consideration why consumers, particularly large-scale consumers or large-scale caterers, do not just already receive their food items in GN containers. The reason might be that, to date, no secure system, no appropriate logistics and no suitable organisation existed.

The present principle of packaging and delivering food includes evacuating, preferably in plastic bags, the provision of a protective atmosphere, or deep-freezing.

The advantage of evacuating is a long storability since oxygen was removed. What is disadvantageous is that the food is in direct contact with plastics, and not protected from incident light, that there is no protection from mechanic effects, and that the whole thing is, optically, not nice to look at.

The advantages of working with a protective atmosphere are the long storability since the oxygen is replaced by gas, and an optically improved appearance. The disadvantages are that the food is in direct contact with plastics, that there is no protection from incident light, and that there is no protection from mechanic effects either.

Deep-freezing, owing to the low temperature, has the advantage of a long storability, and of an optically improved appearance. The disadvantages are a direct contact of the food with plastics, an extremely high energy consumption during storage, an extremely high energy consumption while cooking, the loss of quality, vitamins and nutrients as well as the destruction of the cell structure.

The fact that uncountable tons of garbage are produced by this present principle, that 35% the food are thrown away, and that the food is, in addition, contaminated by the plastic material (more precisely, by the plasticisers contained in the plastic material) was already addressed above.

It is the object of the invention to eliminate these disadvantages and problems.

### SUMMARY OF THE INVENTION

Based on a system of the type described in the beginning the object is, according to the invention, solved by the Internet platform being designed to present the suppliers' offer to the customers and to establish a direct or indirect contact between the customer and the supplier to deliver food filled into reusable containers by the supplier to the customer as packaged food which is kept hot or cooled.

Here, preferably, GN containers made of stainless steel are used as reusable containers. Premium steel neutralises odours in connection with oxygen and humidity. Since no plastic material contacts the food it cannot be contaminated by plasticisers. Nevertheless steel is hygienic, food-safe, odourless, robust, dishwashable, and easy to clean. Apart from that, such reusable containers are optimally stackable.

The protection of the food is, in particular, achieved by evacuating and by a protective gas atmosphere in the system according to the invention. Instead of a plastic material, stainless steel is used which, at the same time, affords protection against incident light and mechanical effects, and can be used for a systematic storage.

The Internet platform of the system according to the invention is an online platform on which anyone earning his/her money with food (food producers, grocers, food distributers, etc.) can offer of buy products. So the farmer, the butcher, and the producer can be counted among the suppliers while gastronomy, the hotel industry, caterers and care, and particularly wholesalers, retailers and supermarkets can be counted among the customers.

The goods to be transported are fresh foods of all kinds, whether vegetables, fish or meat. The infrastructure of the system according to the invention includes the use of containers, particularly metallic containers which are closable with a vacuum-tight lid, can be evacuated, or can be provided with a protective atmosphere instead of plastic materials. For temperature and transport protection so-called Thermoports by Rieber Co. are used. The lid for the vacuum-tight closing of the container has an intelligent sensor valve for monitoring the temperature, pressure, and time, as well as for exchanging data for safety and logistics. The Thermoports are provided with an intelligent chip for monitoring the temperature, time, as well as for exchanging data for safety and logistics. For logistics, preferably, an already existing infrastructure such as, for example, DHL, UPS etc. is used. The Thermoports, like the GN containers, are respectively part of a return system and guarantee 100% safety and 80% less waste, 60% more vitamins, and 50% less energy.

The advantages attained by the system according to the invention are:
quality, fresh or cooked to the point, perfect temperature and presentation
safe, at any time, at any place,
minimum energy consumption, no packaging waste,
reusable instead of disposable packaging and thus reduction of spoilage,
regional purchase of selected products,
flexible logistics chain—Thermoport instead of freight vehicle size as transport unit, cooled/hot in any vehicle,
no convenience food in the conventional sense, but pre-produced, fresh components,
local products,
optimisation of capacities owing to the purchase of pre-processed components and intelligent pre-production,
massive reduction of the operating costs (primarily of energy and waste).

The Internet platform used according to the invention connects suppliers and customers and provides for an optimum control of the system.

The Internet platform further offers the following the participants in the system:
ordering ready menus or food,
use of apps as software tools, etc.,
infrastructure components can be purchased, leased or rented,
accounting and merchandise management systems (rented software) down to the server infrastructure including mailing systems.

The Internet platform provides for the so-called storefront for the product presentation, registration of customers and ordering, logistics, software tools as a service such as, for example, the calculation of the required amounts, degrees of doneness and cooking times, and, finally, quality control (HACCP).

Large caterers having many large and smaller locations which serve or supply many unprofitable company restaurants (particularly with less than 150 meals), and a sufficient number of nearby commercial kitchens, which, however, cannot all be utilised to capacity, can particularly profit from the system according to the invention because it renders the restructuring of small units by a changeover to the delivery on the basis of the system according to the invention possible, additional new smaller customers in the region can be recruited (use of the commercial kitchens to their full capacity, additional growth), the handling of the ordering system, the accounting and the logistics can be implemented via the system, and therefore no additional manpower is required at the participants of the system.

A major grocer may profit from the system according to the invention by purchasing pre-prepared meals or menu components, making use of the capacities of regional locations, offers at, for example, petrol stations, but also by supplying important customers such as, for example, restaurants via online orders. The integration into the internal ordering and planning system may be implemented by making use of the system according to the invention. Logistics and quality control problems can be solved.

### BRIEF DESCRIPTION OF THE DRAWING

Embodiments the invention will be described in more detail below with reference to the drawing in which:

FIG. 1 shows an embodiment of a system according to the invention.

### DETAILED DESCRIPTION OF THE INVENTION

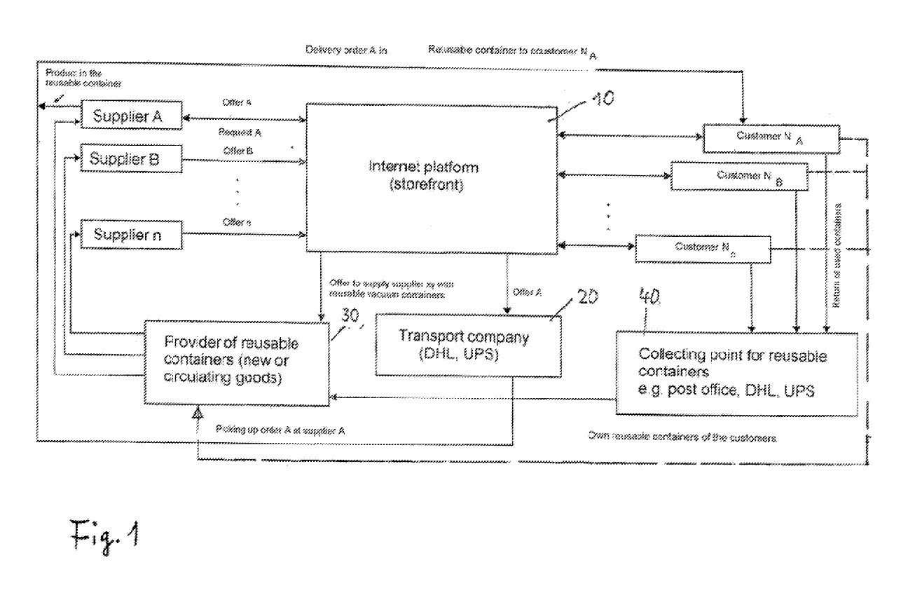

In FIG. 1 a system for the sale of packaged food via an Internet platform 10 provided between suppliers A, B, . . . n and customers N_{A}, N_{B} . . . Nₙ is schematically shown. The Internet platform 10 is designed to present the suppliers' A, B, . . . n offer to the customers N_{A}, N_{B}, . . . Nₙ and to establish a direct or indirect contact between the customer and the supplier to deliver food filled into reusable containers (not shown) by the supplier to the customer as packaged food which is kept hot or cooled. If “customers” and “suppliers” are made reference herein these are, technically speaking, not per se a person or a company but a data station having the capacity for a bidirectional data exchange with the Internet platform 10. The same applies to a provider 30 or a transport company 20 which are explained further below.

If, for example, a customer N_{A} or its data station has discovered that a supplier A has an interesting offer A matching a query A of the customer N_{A} by scanning the Internet platform 10 it may directly place the order to deliver the offered product to it with the supplier A via the Internet platform 10. The supplier A will fill the product into reusable containers, and arrange for the delivery of the order A to the customer N_{A} via logistics existing near it or near the customer N_{A}. This short way from the customer N_{A} to the supplier A and from it to the customer N_{A} 40 will be offered by the Internet platform 10 if the customer N_{A} is a private individual, a small retailer or the like. The customer N_{A} could, in this case, also transport its own reusable containers to the supplier A, have them filled, and then have them transported to the place where the customer N_{A} is located, or to the place to which the order A is to be delivered if it utilises its own logistics for the delivery of the order A to it. The other customers N_{B} . . . Nₙ and suppliers B . . . n may act likewise to transact a placed order B . . . n directly with the customer who placed the order. In case of a caterer, a gastronomic business, a canteen or the like this direct contact between the customer and the supplier via the Internet platform will hardly be usable for lack of appropriate logistics.

Therefore, the Internet platform 10 will establish an indirect contact between the customer and the supplier in such cases. For this purpose a transport company 20 is optionally connectable to each supplier A, B, . . . n via the Internet platform 10 to pick up an order of a customer N_{A}, N_{B} . . . Nₙ received by the Internet platform 10 from the associated supplier and to deliver it to the customer. In FIG. 1, this is indicated by the right arrow “request A” pointing downwards between the Internet platform 10 and the transport company 20. The transport company 20 may be an established logistics company such as DHL, UPS, etc. The transport company 20 will, for example, send a vehicle to the supplier in question, here, for example, the supplier A, to pick up the associated products filled into reusable containers by the supplier A there, and to deliver them to the customer N_{A} as indicated above the Internet platform 10 in FIG. 1.

A provider 30 of reusable containers, here again symbolised by its bidirectional data station, particularly of returnable containers which are food containers vacuum-sealable by a removable lid, particularly metallic GN containers, and may, in addition, contain a protective atmosphere, if required, is connectable to each supplier A, B . . . n to supply it with reusable containers. The latter variant is indicated by broken lines in FIG. 1 showing a broken connection between the customers N_{A}, N_{B} . . . , Nₙ and the provider 30. Of course the customers N_{A}, N_{B} . . . , Nₙ may also directly supply the supplier A, B, . . . n with their own reusable containers. Apart from that the suppliers A, B . . . n could use their own reusable containers instead of having such containers delivered to them.

Further, according to the illustration in FIG. 1, a collecting point 40 for the return of reusable containers, particularly of returnable containers, is providable or provided between the customers N_{A}, N_{B} . . ., Nₙ and the provider 30. If the customers had suitable equipment for cleaning the reusable containers they could also circumvent the collecting point, and supply the provider 30 or the suppliers A, B, . . . n directly with the cleaned reusable containers.

The collecting point 40 which may be located with the transport company 20 will restore the delivered reusable containers to a serviceable condition and then pass them on to the provider 30. If returnable containers are concerned, the reimbursement of the paid deposit may be effected directly between the collecting point 40 and the customers. Usually, however, this will also be invoiced via the Internet platform 10, for which purpose the collecting point will have a connection (not shown) to the Internet platform 10.

1. A system for the sale of packaged food via an Internet platform provided between suppliers and customers, the system comprising
the Internet platform (10) is designed to present the suppliers' (A, B, . . . n) offer to the customers (N_{A}, N_{B}, . . . Nₙ) and to establish a direct or indirect contact between the customer and the supplier to deliver food filled into reusable containers by the supplier to the customer as packaged food which is kept hot or cooled.

2. The system according to claim 1, wherein a transport company (20) is optionally connectable to each supplier (A, B, . . . n) via the Internet platform (10) to pick up an order of a customer (N_{A}, N_{B}, . . . Nₙ) received by the Internet platform (10) at the associated supplier and to deliver it to the customer.

3. The system according to claim 1, wherein a provider (30) of reusable containers, particularly returnable containers which are food containers vacuum-sealable by a removable lid, particularly metallic GN containers, and may, in addition, contain a protective atmosphere, if required, is connectable to each supplier to supply the same with reusable containers.

4. The system according to claim 3, wherein
a collecting point (40) for the return of reusable containers, particularly returnable containers, is providable or provided between the customer (N_{A}, N_{B}, . . Nₙ) and the provider (30) of reusable containers.
